(19) United States
(12) Patent Application Publication
(10) Pub. No.: US 2002/0013152 A1
(43) Pub. Date: Jan. 31, 2002

(54) Method of obtaining a geographical representation of the traffic in a mobile radio network

(75) Inventor: Claire-Sabine Randriamasy, Meudon (FR)

Correspondence Address: SUGHRUE, MION, ZINN, MACPEAK & SEAS, PLLC, Suite 800, 2100 Pennsylvania Avenue, N.W., Washington, DC, 20037-3213, US

(73) Assignee: ALCATEL

(21) Appl. No.: 09/882,018

(22) Filed: Jun. 18, 2001

(30) Foreign Application Priority Data
Jun. 26, 2000 (FR) 00 08 154

(51) Int. Cl. H04Q 7/20

(52) U.S. Cl. 455/453; 455/436

(57) ABSTRACT

A method of constructing a representation of the geographical distribution of traffic for a cellular radio network, the method comprising the steps of:

dividing each cell of said cellular network into a set of areas using information on handovers obtained from said cellular network;

determining a traffic value for each of said areas; and

determining a representation of the geographical distribution of the traffic from said traffic values.

### FIELD OF THE INVENTION

The present invention relates to a method of obtaining a geographical representation of the traffic associated with a cellular mobile radio network. It is particularly suitable for networks conforming to the GSM or equivalent standards.

To be more precise, an object of the invention is to determine a precise correspondence between points of the terrain over which the radio network is deployed and traffic in terms of calls between mobile telecommunications terminals and base stations.

Knowing this correspondence, a telecommunications operator is able to identify areas in which the traffic is too high in relation to the resources (in particular base stations) deployed and to envisage pertinent corrective action.

### BACKGROUND OF THE INVENTION

Prior art solutions associate a traffic value with each cell.

A cell is a geographical area in which all (or substantially all) the mobile terminals are connected to the same base station. As a mobile terminal moves around, the call set up with one base station can be degraded to the point that it is necessary to set up a new call to another base station, i.e. to change cell. This mechanism is generally referred to as handover.

Telemate Parcell software is one example of that prior art.

That kind of solution is not satisfactory, however. This is because the cells are usually relatively large. The accuracy is therefore low and the traffic value obtained for a given cell is usually not particularly representative of reality.

For example, in an urban context, the size of a cell is approximately 300 m by 300 m. An area this large can encompass both high traffic areas (commercial or industrial centers, etc.) and low traffic areas (parks, residential areas, etc.). In this case, the overall traffic value is the average of the traffic values for the high and low traffic areas. Consequently, even if the traffic value for one of the high traffic areas is extremely high, and would necessitate corrective action (by adding a base station to divide the cell into two cells, for example), the traffic value over the cell as a whole might be entirely normal. Thus no alarm could be generated and, more importantly, no corrective action taken.

It is therefore very important to obtain a representation of the traffic that is more precise than that obtained at cell level.

### OBJECT AND SUMMARY OF THE INVENTION

An object of the present invention is to provide this kind of representation. To this end, the present invention provides a method of constructing a representation of the geographical distribution of traffic for a cellular radio network. The method comprises the steps of:

dividing each cell of said cellular network into a set of areas using information on handovers obtained from said cellular network;

determining a traffic value for each of said areas; and

determining a representation of the geographical distribution of the traffic from the previously computed traffic values.

### BRIEF DESCRIPTION OF THE DRAWINGS

The invention and its advantages become more clearly apparent in the course of the following description, which is given with reference to the accompanying drawings.

FIG. 1 shows a device for implementing a method according to the invention.

FIG. 2 is a flowchart showing the steps of a method in accordance with the invention.

FIGS. 3 and 4 show steps of the method by means of an example of an area in the vicinity of a cell.

### MORE DETAILED DESCRIPTION

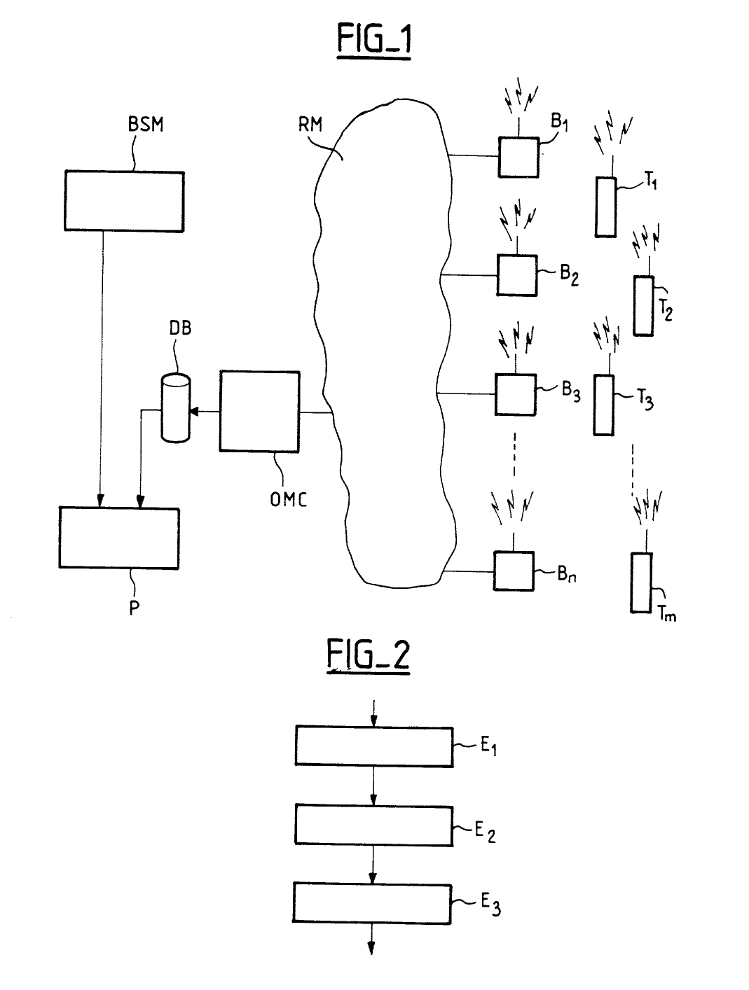

FIG. 1 shows a device for implementing a method in accordance with the invention. The device comprises a mobile telecommunications network RM including a set of base stations B₁, B₂, B₃, . . . Bₙ having means for communicating via electromagnetic waves with a set of mobile terminals T₁, T₂, T₃, . . . Tₙ.

The mobile telecommunications network RM is connected to one or more management systems in the form of operation and maintenance centers (OMC) as defined by the GSM 12.00 standard. The management systems OMC provide local supervision of the equipment of the mobile telecommunications network. They are part of a telecommunications management network (TMN), not shown in the figure. The functions of the TMN and OMC are conventionally divided into five groups:

Management of mobile telecommunications network equipment faults,

Configuration management,

Performance management,

Call charging management, and

Security management.

To this end, the TMN and OMC have access to information relating to the equipment and in particular to the base stations B₁, B₂, B₃, Bₙ.

That information is made up of indicators which are defined in part by the GSM 12.04 standard. The standard defines only relatively low level indicators. Most manufacturers add to these standard indicators other indicators that are often obtained by combining indicators from the GSM standard.

Examples of indicators are:

An indicator that represents the channel occupation time,

An indicator that represents call attempts (which can be regarded as a traffic estimator),

An indicator that represents the number of incoming handovers, and

An indicator that represents the number of outgoing handovers.

A distinction is made hereinafter between incoming handovers and outgoing handovers.

An outgoing handover takes place in a first cell when a mobile terminal sets up a new connection to the base station of a second cell. An incoming handover takes place in the first cell in the opposite situation, i.e. when a mobile terminal sets up a new connection to the base station of the first cell. In other words, if a mobile terminal moves from a first cell to a second cell (handover), there is an outgoing handover in the first cell and an incoming handover in the second cell.

The device shown further includes a database DB for storing data from the management system OMC. The database stores information relating to the mobile telecommunications network equipment over a long period, for example several months. This provides a long-term overview of the behavior of the mobile telecommunications network RM, and is therefore independent of episodic phenomena that can affect the network.

Also, the device shown in FIG. 1 includes a server BSM providing one or more best server maps. These maps are generally created and used when planning the cellular telecommunications network. They establish the correspondence between points in a geographical area and the base station to which a mobile terminal at that point would most probably be connected.

They are based on models of the geographical area and electromagnetic wave propagation conditions and provide a theoretical knowledge of the geographical extent of the cells.

FIG. 2 is a flowchart of the method used by a planning tool P.

The first step E₁ shown in FIG. 2 divides the cells into subcells using information relating to handovers obtained from the management system OMC and stored in the database DB.

A first substep computes the boundaries of incoming handovers. This step is usually a step in the construction of the best server maps. The incoming handover boundary can therefore be made available by the server BSM.

Note that a cell of the best server map consists of points in space at which the power of the signal received by a mobile from a base station (B₁, B₂, B₃, . . . Bₙ) is greater than that received from other base stations of the network.

That power is not constant within a cell, however. The power can be fairly low, in particular near the cell boundaries. The incoming handover boundary is then defined as the locus of points for which the power is above a particular threshold.

An outgoing handover boundary is then computed from the incoming handover boundary. The outgoing handover boundary can be defined as the curve at a distance d from the incoming handover boundary, the distance d being computed by multiplying the average speed of the mobile terminals over a cell by their channel occupation time. Note that the distance d is different for each cell.

The channel occupation time can be supplied directly by an indicator provided by the management system OMC.

The average speed of the mobile terminals is a parameter of the method. It can be determined either once and for all or each time that the method according to the invention is used.

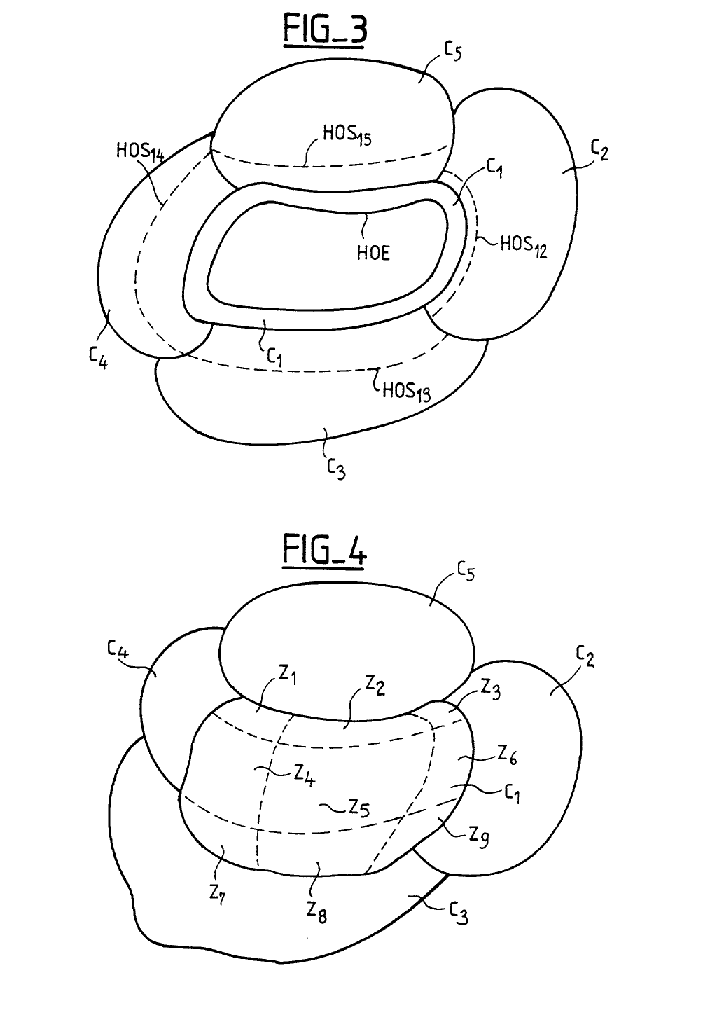

FIG. 3 shows the computation of the outgoing handover boundary. The cell C₁ has adjacent cells C₂, C₃, C₄ and C₅. The management system OMC supplies the incoming handover boundary HOE. As previously indicated, the outgoing handover boundary HOS can then be computed.

The outgoing handover boundary HOS is located in the adjacent cells C₂, C₃, C₄ and C₅, which it divides into two parts: one short of the boundary and one beyond it.

The next step E₂ shown in FIG. 2 uses the outgoing handover boundaries to determine areas within each cell.

In the same way, outgoing handover boundaries can be computed for each of the adjacent cells, as shown in FIG. 4.

The dashed lines HOS₂, HOS₃, HOS₄ and HOS₅ represent the respective outgoing handover boundaries computed for the cells C₂, C₃, C₄ and C₅.

Those four boundaries, corresponding to the four cells adjacent the cell C₁, divide the cells C₁ into nine areas z₁, z₂, z₃, z₄, z₅, z₆, z₇, z₈ and z₉.

The next step E₃ shown in FIG. 2 determines a traffic value associated with each area.

This can be done by minimizing the differences between the traffic values of two adjacent areas. It is assumed that the traffic is a continuous function and that there must be no discontinuities in the model.

Hereinafter, λᵢ denotes the traffic value for area i. The above principle can then be expressed in the form of a function f to be minimized:

$$f ( {λ}_{1} , {λ}_{2} , {λ}_{3} … {λ}_{n} ) = {\sum }_{i = 1}^{n} {∇}_{i}$$

in which n is the number of areas and ∇ᵢ is the sum of the differences between the traffic value of area i and the traffic values of all the areas adjacent it.

The above expression can take various forms.

It can be expressed in quadratic form:

$${∇}_{i} = {\sum }_{j ∈ {V}_{i}} {( {λ}_{i} - {λ}_{j} )}^{2}$$

where Vᵢ is the set of indices of areas adjacent area i.

The value ∇ᵢ can also be expressed in linear form:

$${∇}_{i} = {\sum }_{j ∈ {V}_{i}} \vert {λ}_{i} - {λ}_{j} \vert$$

It is also possible to write two constraints that the traffic values λ₁, λ₂, λ₃, . . . λₙ must respect:

The sum of the traffic values of the areas of a cell must be equal to the traffic value for that cell.

The sum of the estimated handovers for each area of a cell must be equal to the number of handovers for that cell.

The first constraint for each cell i can be written as follows:

$${\sum }_{k ∈ J ( i )} {λ}_{k} = {t}_{i}$$

in which J(i) is the set of indices of the areas belonging to cell i and tᵢ is the traffic value for cell i. The traffic value tᵢ is known to the management system OMC.

The second constraint enables the following equation to be written for each pair of cells (Cᵢ, Cⱼ):

$${α}_{1} \cdot {\sum }_{k ∈ {J}_{1} ( i , j )} {λ}_{k} + {α}_{2} \cdot {\sum }_{k ∈ {J}_{2} ( i , j )} {λ}_{k} = HO ( i , j )$$

in which equation HO(i, j) represents the number of handovers from cell i to cell j.

In the above expression, a distinction is made between two types of area contained in the cell Cᵢ:

on the one hand, areas near the cell Cᵢ. For these areas, the probability a₁ that a call will be subject to a handover is relatively high. The set of these areas is denoted J₁(i,j).

on the other hand, the other areas of the cell Cᵢ.

For these areas, the probability a₂ that a call will be subject to a handover is relatively low.

The set of these areas is denoted J₂(I,j). Note that ∀I,j J₁(i,j)∪J₂(i,j)=J(i), the symbol ∪ denoting the union of two sets.

For example, referring to FIG. 4, if the handovers occur between the cell C₁ and the cell C₂, the following constraint equation can be written:

α₁·[λ₆+λ₉+λ₃]+α₂·[λ₄+λ₅+λ₂+λ₇+λ₈+λ₁]=HO (1, 2)

A function of n variables to be minimized under p≦n constraints is therefore obtained. This optimization problem is conventional in itself, and can be solved by methods known in the art.

For example, see “Practical Methods of Optimization: constrained Optimization”, R. Fletcher, Wiley & Sons, 1981. A preferred approach uses the quadratic form of the criterion f(λ₁, λ₂. . . λₙ) and solves the problem by an iterative method, which produces traffic values λᵢ all of which are non-zero and in accordance with the operational constraints.

The values of the probabilities α₁ and α₂ can be determined empirically in some cases.

However, in a preferred embodiment of the invention these values are computed in a constraint minimization step, at the same time as the other variables.

This is because, in most cases, it is not possible to obtain a pair ((α₁, α₂) that has a constant value over the network. It is necessary to consider a pair [α₁(i,j), α₂(i,j)] for each pair of cells between which there are handovers.

For the remainder of the description, it is therefore more pertinent to consider the proportion Q between the values of α₁ and α₂, that proportion being defined by the equation:

α₂(i,j)=Q·α₁(i,j) , ∀i,j

The proportion Q can be fixed empirically, for example at a value close to ½.

The second constraint can then written in the form:

$${α}_{1} ( i , j ) \cdot [ {\sum }_{k ∈ {J}_{1} ( i , j )} {λ}_{k} + {\sum }_{k ∈ {J}_{2} ( i , j )} {λ}_{k} + ( Q - 1 ) \cdot {\sum }_{k ∈ {J}_{2} ( i , j )} {λ}_{k} ] = HO ( i , j )$$

Because

$${\sum }_{k = J ( i )} {λ}_{k} = {t}_{i}$$

and J₁(i,j) ∪J₂(i,j)=J(i), the above expression can be written:

$${t}_{i} + ( Q - 1 ) \cdot {\sum }_{k ∈ {J}_{2} ( i , j )} {λ}_{k} = \frac{1}{{α}_{1} ( i , j )} \cdot HO ( i , j )$$

Assuming that the probability of a mobile effecting a handover in an area of type “α₁” (i.e. near another cell) is non-zero, it can be stated that

$${p}_{ij} = \frac{1}{{α}_{1} ( i , j )} .$$

The following expression is then obtained for the second constraint:

$$( Q - 1 ) \cdot {\sum }_{k ∈ {J}_{2} ( i , j )} {λ}_{k} - {p}_{ij} \cdot HO ( i , j ) = - {t}_{i}$$

To take account of the fact that the probabilities are not known, the expression of the criterion to be minimized must be modified. The criterion f then becomes a function of the traffic values λᵢ and the handover probabilities α₁(i,j)

For example:

$$S ( Λ , A ) = {\sum }_{i = 1}^{n} {∇}_{i} + {\sum }_{i = 1}^{n} {\sum }_{j ∈ V ( i )} {[ \frac{{t}_{i}}{HO ( i , j )} - {p}_{ij} ]}^{2}$$

where Λ=(λ₁, λ₂, λ₃. . . λₙ ) and A=[α₁(1,1); α₁(1,2) . . . α₁(1, V (1) (xl(2, 1); α₁(2, 2) . . . α₁(2,V(2)) . . . α₁(n,1); α₁(n,V(n))]

The criterion can be minimized, subject to the constraints previously stated, using prior art methods, such as those previously referred to.

1. A method of constructing a representation of the geographical distribution of traffic for a cellular radio network, the method comprising the steps of:
dividing each cell of said cellular network into a set of areas using information on handovers obtained from said cellular network;
determining a traffic value for each of said areas; and
determining a representation of the geographical distribution of the traffic from said traffic values.

2. A method according to claim 1, wherein the traffic value of an area depends on a handover probability associated with that area.

3. A method according to claim 2, wherein said handover probabilities are computed conjointly with said traffic values by a constraint optimization method.

4. A method according to claim 1, wherein the step of dividing each cell is made up of the following substeps:
acquiring incoming handover boundaries from best server maps provided by a management system, and
computing outgoing handover boundaries from said incoming handover boundaries,
said outgoing handover boundaries forming the boundaries of said areas.
